(19) United States
(12) Patent Application Publication
(10) Pub. No.: US 2013/0298216 A1
(43) Pub. Date: Nov. 7, 2013

(54) SINGLE SIGN-ON ACCOUNT MANAGEMENT FOR A DISPLAY DEVICE

(71) Applicant: Vsevolod Kuznetsov, Sankt-Petersburg (RU)

(72) Inventor: Vsevolod Kuznetsov, Sankt-Petersburg (RU)

(73) Assignee: RAWLLIN INTERNATIONAL INC.

(21) Appl. No.: 13/464,673

(22) Filed: May 4, 2012

(51) Int. Cl. G06F 21/00

(52) U.S. Cl. 726/8

(57) ABSTRACT

Providing for single sign on functionality implemented for a network-enabled display device is described herein. By way of example, single sign on functionality can comprise accessing stored login credentials for a set of online content or service accounts, and initiating login requests to respective online servers for these accounts in response to a successful user verification or successful login to a subscriber account associated with the network-enabled display device. A user profile created for the network-enabled display device can comprise login credentials for online multimedia television content/services, and include login credentials for one or more other online accounts. Thus, upon successfully logging into a user's television services, other online accounts can be automatically logged in and access provided over the network-enabled display device, significantly reducing overhead involved in accessing online content from multiple service providers.

### TECHNICAL FIELD

The subject disclosure relates generally to an electronic display device, and more particularly to single sign on account management functionality for the electronic display device.

### BACKGROUND

The advent of the Internet and widespread consumer access to network-stored multimedia content has greatly expanded the scope and availability of electronic communication and electronic content services. For instance, electronic communication has become a backbone of modern commercial and personal communications worldwide, and mobile messaging has increasingly become common for both business and personal communications. Other forms of electronic communication (e.g., digital voice, digital video, etc.) have also become popular, utilizing the fundamental architecture of the Internet and associated webs or networks for the underlying communication platform.

Additionally, content and service providers have integrated large capacity data storage in conjunction with multi-access servers, to facilitate delivering subsets of stored content to users, on request. This framework enables content providers to charge for content services through a subscription account, or the like. Common modern examples include multimedia content such as movies, episode-based television content such as sitcoms, news programs, and other audio/video content, as well as audio content, and even real time interactive audio/video content. Different content/service providers generally provide subscription-based access to their content/services. Thus, a particular user might hold a set of subscription accounts to receive online multimedia content, mobile phone services, and online e-mail services, for instance.

Online television content has become an increasingly popular application for online multimedia content/services. Network television services typically involve delivering audio and video content over a network connection (e.g., an Internet connection, an intranet connection, . . . ) to a television device that in turn is configured to communicate via its own network connection, and receive and playback the audio and video content. Network television services provide several advantages over traditional broadcast or cable television services. First, network television content can generally be stored persistently on a network data store, and accessed through a multi-access server, meaning multiple client devices (e.g., network-enabled television, personal computer, laptop computer, smart phone, tablet computer, . . . ) can access and consume respective subsets of television content at their initiation; a provider of the network television content is not required to initiate transmission of a particular program to the client devices. This results in a far greater degree of consumer-directed control over content with far fewer channels (and radio/cable bandwidth) than are typically required for broadcast television services. Second, network television content can leverage existing network communication pathways, in effect reducing the overall infrastructure equipment associated with delivering television services, radio services, or other multimedia content services, and general network data services (e.g., web browsing, online shopping, . . . ) to consumers. Third, by leveraging public networks, like the Internet, and existing access to those networks, a more direct connection between service provider and consumer is possible, with relatively direct client-server communication between the consumer and service provider. This, along with reduced content delivery infrastructure, results in content delivery more quickly, efficiently and at greatly reduced cost, benefiting both the service provider and consumer.

Because network multimedia content is managed via client-server communications over a network, client authorization and user verification procedures are employed to control client access to content. A server might, for instance, be provisioned to check that a client device is associated with a subscription account offered by a particular content provider. This allows a service provider to limit content delivery only to those users who have an agreement with the service provider, as well as protect intellectual property rights of content owners. As content consumption technology (e.g., display technology, playback technology, . . . ), network capacity technology, consumer data rates, and other aspects of online content delivery change, providers typically adapt their services to achieve new possibilities made available by technological changes. This evolution in technology is ongoing, and is one of many current challenges related to online multimedia content delivery.

### SUMMARY

The following description and the annexed drawings set forth in detail certain illustrative aspects of the disclosed subject matter. These aspects are indicative, however, of but a few of the various ways, or embodiments, in which the principles of the disclosed subject matter may be implemented. The disclosed subject matter is intended to include all such embodiments and their equivalents. Other advantages and distinctive features of the disclosed subject matter will become apparent from the following detailed description of the various embodiments when considered in conjunction with the drawings.

The subject disclosure provides for single sign on functionality implemented for a network-enabled display device. In some aspects, single sign on functionality can comprise accessing stored login credentials for a set of online content or service accounts, and initiating login requests to respective online servers for these accounts in response to a successful login to a subscriber account associated with the network-enabled display device. In a particular aspect, a user profile created on the network-enabled display device, or maintained by a content/service provider facilitating online services for the display device, can incorporate login credentials for access to a first set of online content services (e.g., multimedia television content), and can also store login credentials for one or more other online accounts (e.g., e-mail, instant message, short message, multimedia message, mobile phone, social network, web page, blog page, and so on). Thus, upon successfully logging into a user account or primary user services account, other online accounts can be automatically logged in and access provided over the network-enabled display device, significantly reducing overhead involved in accessing online content from multiple service providers.

In other disclosed aspects, access to online content/service account single sign on functionality can be offered in response to a successful graphical code-based user authorization. In these aspects, a network-enabled display device can obtain and display a picture of an identification code on a display screen of the television. The code can be received from a network server associated with user authorization for multimedia television services, or can be generated by the network-enabled display device. User input on a human machine interface associated with the network-enabled television (e.g., remote control, front panel buttons, side panel buttons, . . . ) can facilitate user entry of input data, and if the input data matches the identification code, access to account functionality can be provided in response (e.g., unrestricted account access, unrestricted content/service access, access to promotional or bonus content, and so on). This access to account functionality can include initiation of single sign on account login for stored online accounts associated with a subscriber account, as discussed above.

In further disclosed aspects, the subject disclosure can provide digital rights management capability in conjunction with online account single sign capacity for a network-enabled display device. Digital rights management can be employed, for instance, to impose a constraint on providing access to content or services based on a display device status, which can be defined by a digital rights management protocol. In further aspects, digital rights management can be employed to decode a video identification code associated with user verification, as a condition to implementing single sign on to multiple online accounts stored at a network-enabled display device. In another aspect, digital rights management can be employed in conjunction with decoding content received from a content server following single sign on to that and other servers.

In other aspects of the subject disclosure, remote access to content or services registered for a particular device is provided. Remote access can enable a user to access content or services, including single sign on account functionality, at a device other than a network-enabled display device that maintains a single sign on account for the user, or that is pre-designated with a service provider that maintains such a single sign on account. Remote access can incorporate graphical code user authorization for account login in some aspects. Additionally, remote access can incorporate digital rights management protocols for account login, in other aspects. Combinations of one or more disclosed aspects are considered within the scope of the subject disclosure as well.

The following description and the annexed drawings set forth in detail certain illustrative aspects of the disclosed subject matter. These aspects are indicative, however, of but a few of the various ways in which the principles of the innovation can be employed and the disclosed subject matter is intended to include all such aspects and their equivalents. Other advantages and novel features of the disclosed subject matter will become apparent from the following detailed description of the innovation when considered in conjunction with the drawings.

### BRIEF DESCRIPTION OF THE DRAWINGS

FIG. 1 illustrates a block diagram of an example network-enabled television comprising single sign on (SSO) features according to aspects disclosed herein.

FIG. 2 depicts a block diagram of a sample network-enabled television configured for multiple user accounts and related sub-accounts, in one or more aspects.

FIG. 3 illustrates a block diagram of an example network environment providing SSO capabilities in conjunction with online television services.

FIG. 4 depicts a block diagram of an example network environment employing digital rights management (DRM) in conjunction with SSO capabilities.

FIG. 5 depicts a block diagram of a sample network-enabled television that provides video code user authorization and DRM decoding in a SSO context.

FIG. 6 illustrates a diagram of an example system for providing remote access to single sign on account functionality according to particular disclosed aspects.

FIG. 7 illustrates a flowchart of a sample method providing automated SSO at a network-enabled television device, according to additional aspects.

FIGS. 8 and 9 depict a flowchart of a sample method providing video code user verification combined with SSO capabilities for a network-enabled television.

FIG. 10 depicts a flowchart of a sample method facilitating video code user authorization and DRM decoding in conjunction with SSO capabilities.

FIG. 11 illustrates a flowchart of an example method for user account login according to one or more particular aspects of the subject disclosure.

FIG. 12 illustrates a block diagram of an example electronic computing environment that can be implemented in conjunction with one or more aspects.

FIG. 13 depicts a block diagram of an example data communication network that can be operable in conjunction with various aspects described herein.

### DETAILED DESCRIPTION

The disclosed subject matter is described with reference to the drawings, wherein like reference numerals are used to refer to like elements throughout the description. In the following description, for purposes of explanation, numerous specific details are set forth in order to provide a thorough understanding of the subject innovation. It may be evident, however, that the disclosed subject matter may be practiced without these specific details. In other instances, well-known structures and devices are shown in block diagram or schematic form in order to facilitate describing the subject innovation.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

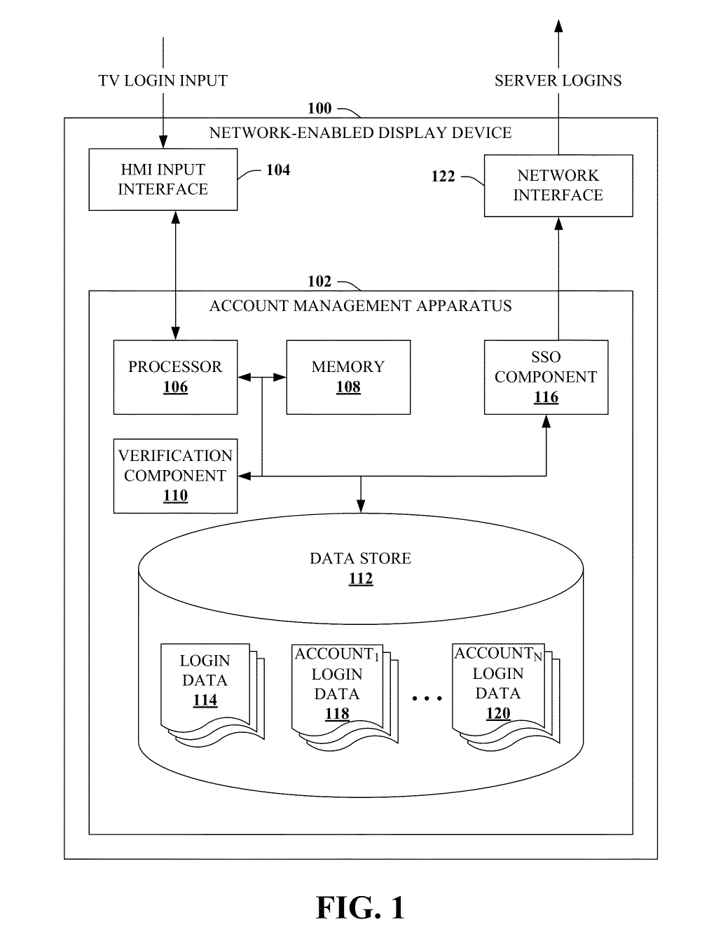

FIG. 1 illustrates a block diagram of an example network-enabled display device 100 according to various aspects of the subject disclosure. Network-enabled display device 100 can be configured to provide single sign on (SSO) functionality for a set of online content or service accounts in conjunction with logging into a user account maintained by network-enabled display device 100, or a user account maintained by a service provider offering services related to network-enabled display device 100. For instance, in the event that network-enabled display device 100 is a network-enabled television, network-enabled set-top box, or the like, the account can be an online television content account maintained by a television content service provider, as one particular example. Thus, the user account can be maintained by network-enabled display device 100, or a related network login server (not depicted) configured to manage related services.

Network-enabled display device 100 can comprise an account management apparatus 102 configured to facilitate user account login capabilities related to network-enabled display device 100. Additionally, account management apparatus 102 can be configured to store login credentials for online content or service accounts, and initiate login procedures to those accounts. Although account management apparatus 102 is depicted as being a part of network-enabled display device 100, it should be appreciated that account management apparatus 102 can also by physically separate from, and communicatively connected to, network-enabled display device 100 in an alternative embodiment of the subject disclosure.

As depicted, network-enabled display device 100 can comprise a human machine interface (HMI) input interface 104 suitable for inputting data, commands or control functions to network-enabled display device 100. HMI input interface 104 can include a remote control receiver, television panel buttons, or the like, or a suitable combination thereof. Moreover, network-enabled display device 100 can comprise a network interface 122 for transmitting data to, or receiving data from, a data network. Suitable data networks can include an Internet Protocol (IP)-based network, an 802.11x (where x can be a, b, g, n, . . . ) protocol network, such as a local area network (LAN) or wide area network (WAN), an intranet, the Internet, and so on. In at least one aspect, network interface 122 can comprise a mobile network interface suitable for communication with a terrestrial radio access network (such as a global system for mobile communication [GSM] network, code division multiple access [CDMA] network, high speed packet access [HSPA] network, etc.), which can be employed for accessing the Internet or other data networks connected to the terrestrial radio access network by a mobile service provider.

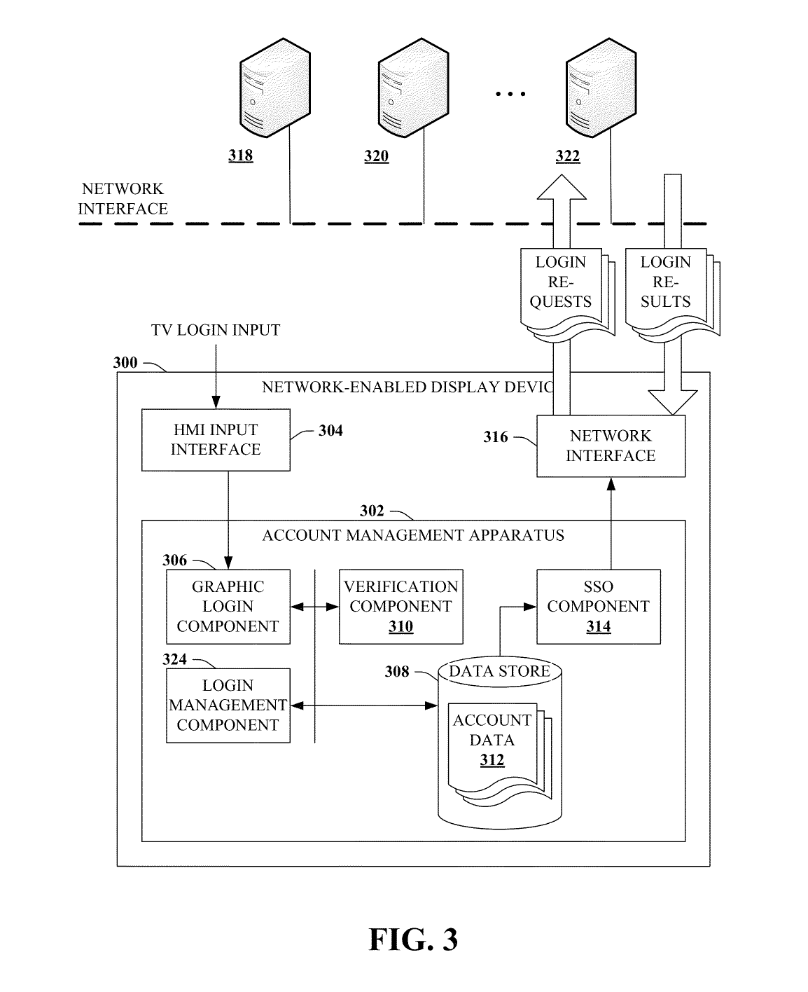

According to particular aspects of the subject disclosure, account management apparatus 102 can comprise a memory 108 that can be configured to store computer-executable components of account management apparatus 102, and a processor 106 communicatively connected to memory 108 and configured to facilitate execution of at least one of the computer-executable components. As utilized herein, computer-executable components can include one or more components of a disclosed apparatus (e.g., account management apparatus 102, account management apparatus 302 of FIG. 3, etc.), or a subset of such components. In one aspect, a subset of a component can include a subset of hardware (e.g., circuitry, power source, memory, . . . ) or a subset of software (e.g., programming, rules of operation, stored parameters or parameter values, related data, . . . ) pertaining to the component.

Account management apparatus 102 can additionally comprise a verification component 110 configured to obtain account login credentials pertaining to network-enabled display device 100 or a related content or service account, and verify whether the account login credentials match stored credentials for one or more user accounts associated with network-enabled display device 100. Entry of login credentials can be in response to a request or query for such credentials on a video display (not depicted) of network-enabled display device 100. As one example, verification component 110 can obtain a set, e.g., a list, of stored user accounts maintained by a data store 112 and set the stored user accounts on network-enabled display device 100 for selection by a user/viewer thereof. Selection of one of the listed stored user accounts of the set can prompt verification component 110 to display the request/query for the login credentials pertaining to the selected user account.

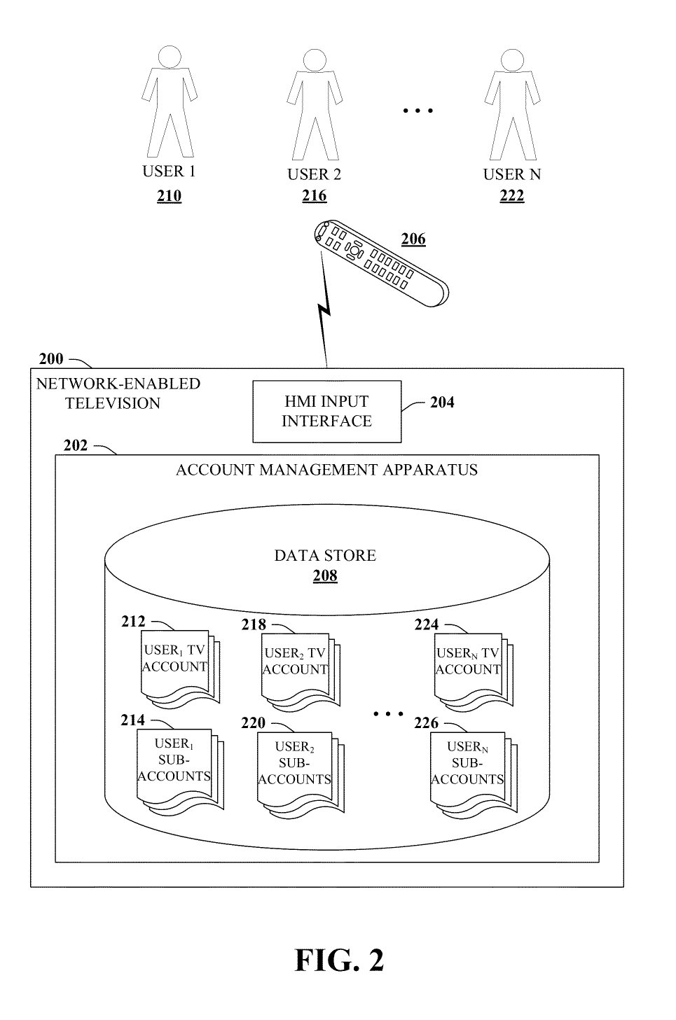

Further to the above, login credentials can be received via a data or signal input mechanism of network-enabled display device 100. As depicted, a data or signal input mechanism can include HMI input interface 104, or network interface 122. In the former case, a user can enter login credentials with a remote control programmed for network-enabled display device 100 (e.g., see FIG. 2, infra), or can enter login credentials on buttons, switches, etc., on a panel of network-enabled display device 100. In the latter case, login credentials can be entered over a data network to network interface 122.

In response to receiving login credentials, verification component 110 can reference a primary login data file 114 maintained by data store 112. Primary login data file 114 can be configured to store login credentials (e.g., username and password, . . . ) for a set of primary user accounts for one or more users of network-enabled display device 100. The primary user accounts can include an account(s) established by an online content/service provider, or an account established at and maintained by network-enabled display device 100 or account management apparatus 102, at least in part in conjunction with the online content/services provider, or independent of such content/services provider. If login credentials match stored login credentials for a primary user account (or, for example, a selected primary user account), verification component 110 can activate the primary user account, and provide access to content or features associated with the primary user account through network-enabled display device 100.

In response to activating the primary user account, a SSO component 116 can identify a set of online content or services accounts (e.g., secondary accounts) linked with the primary user account, and stored in data store 112 (also, see FIG. 2, infra). These online content/services accounts can include an e-mail account(s) (e.g., a web mail account, a private email account maintained by a private e-mail server, such as a business e-mail server, or the like), a social network account(s) (e.g., Facebook, Twitter, LinkedIn, . . . ), a web page account(s), a message board account(s), a web blog account(s), a network messaging account(s), a mobile phone account(s), a text messaging account(s), a short message service messaging account(s), a multimedia message service messaging account(s), an online multimedia content account(s), or the like, or a suitable combination thereof. Login credentials for respective online content/services accounts can be stored in a set of account login files, including account₁ login data file 118 . . . account_{N} login data file 120 (referred to collectively as account login data files 118-120), where N is a suitable positive integer.

SSO component 116 can be configured to initiate login procedures for the online content/service accounts. For instance, network addresses of respective login servers (not depicted) can be retrieved, for instance, from account login data files 118-120. These network addresses can be utilized to transmit respective login requests over network interface 122 to associated login servers managing login activity for those accounts. In response to one or more successful logins, network interface 122 and network-enabled display device 100 can be utilized to request and receive content/services associated with successfully logged in online content/service accounts, including a primary user account, if the primary user account is a content/service related account. The SSO functionality of account management apparatus 102 can alleviate significant overhead in manually logging in to multiple network accounts that are otherwise unrelated to a subscriber account for online multimedia television services pertaining to network-enabled television. Thus, after logging into a primary account at network-enabled display device 100, a user can access other content/services (e.g., e-mail, web blog, social network, . . . ) via network-enabled display device 100 without having to manually log into respective accounts associated with those content/services.

FIG. 2 illustrates a block diagram of an example network-enabled television 200 according to still other aspects of the subject disclosure. Network-enabled television 200 can comprise an Internet Protocol television (IP-TV), a network-connected set-top box connected with a television device, or other suitable television display device configured for communication with a data network. In at least one aspect of the subject disclosure, network-enabled television 200 can be substantially similar to network-enabled display device 100 of FIG. 1 (or network-enabled display device 300, 402, 500 disclosed herein). The subject disclosure is not so limited, however, and network-enabled television 200 can have a subset of the features of network-enabled display device 100, 300, 402, 500, or additional features described below, and vice versa.

Network-enabled television 200 can comprise an account management apparatus 202 configured to manage user accounts for a set of users of network-enabled television 200. As depicted, users include user₁ 210, user₂ 216 through user_{N} 222 (referred to collectively as users 210, 216, 222). A remote control 206 or other HMI input (e.g., control buttons—not depicted—on network-enabled television 200) can be utilized by users 210, 216, 222 to enter login credentials to log into their respective accounts. Login credentials received at an HMI input interface 204 of network-enabled television 200 can be forwarded to account management apparatus 202.

Account management apparatus 202 can compare received login credentials to a set of stored login credentials. The stored login credentials can be linked with logging in to one or more user accounts previously established by users 210, 216, 222 at network-enabled television 200. Alternatively, the stored login credentials can be linked with one or more subscription accounts for online multimedia television services previously established by users 210, 216, 222 with a television services provider, and for which login credentials are forwarded to network-enabled display device 100 and stored by account management apparatus 202.

As depicted, account management apparatus 202 can comprise a data store 208. Although data store 208 is depicted as part of account management apparatus 202, in an alternative embodiment data store 208 can be separate from account management apparatus 202 and communicatively connected there with. In the latter embodiment, data store 208 can be external to account management apparatus 202 and internal to network-enabled television 200, or external to both account management apparatus 202 and network-enabled television.

Data store 208 maintains a set of files that store login credentials for users 210, 216, 222. The set of files include user₁ television account file 212, user₂ television account file 218 through user_{N} television account file 224 (referred to collectively as television account files 212, 218, 224). In at least one aspect, television account files 212, 218, 224 can also store information pertaining to features and content of network-enabled television 200 or pertaining to online multimedia television services associated with the respective accounts (including associated content, parental control settings, content or viewing limitations, . . . ). Additionally, each of the television account files 212, 218, 224 can be associated with a respective set of user sub-account files, including user₁ sub-accounts file 214, user₂ sub-accounts file 220 through user_{N} sub-accounts file 226 (referred to collectively as user sub-accounts files 214, 220, 226). User sub-accounts files 214, 220, 226 can store login credentials for respective sets of online content/service accounts associated with respective television account files 212, 218, 224. These user sub-accounts files 214, 220, 226 can be loaded with the stored login credentials by users 210, 216, 222 upon creation of respective television account files 212, 218, 224 and user sub-accounts files 214, 220, 226.

Login credentials received by account management apparatus 202 can be referenced to one or more stored login credentials maintained by television account files 212, 218, 224 to determine whether received login credentials match a (selected) television account. If a match is identified, account management apparatus 202 can activate one or more user television accounts, and provide access to content or services associated with such account(s) at network-enabled television 200. Additionally, account management apparatus 202 can attempt to automatically log in to the user sub-accounts associated with the activated user television account(s), as described herein. Users 210, 216, 222 can also switch from one activated television account to another by inputting a suitable command to network-enabled television 200, and providing login credentials for a different television account. If the login credentials match stored login credentials of the different television account, account management apparatus 202 can activate the different television account, and attempt to log in to sub-accounts associated there with.

FIG. 3 illustrates a block diagram of an example client-server communication environment according to one or more further aspects of the subject disclosure. The client-server communication environment can comprise a network-enabled display device 300, acting as a client for the client-server communication, and a set of online login servers 318, 320, 322 (referred to collectively as login servers 318-322), acting as servers for the client-server communication.

Network-enabled display device 300 can comprise an account management apparatus 302 configured to authenticate a user/viewer of network-enabled display device 300. In response to authenticating the user/viewer, account management apparatus 302 can be further configured to initiate login procedures to one or more of login servers 318-322 to activate a set of online content/service accounts associated with the user/viewer. In a particular aspect, account management apparatus 302 can employ a video verification code for authenticating the user/viewer, providing a mechanism to differentiate the user/viewer from an automated login (e.g., a computer or bot program attempting to log in to an account instead of a person).

To implement video verification log in, account management apparatus 302 can comprise a graphic login component 306 configured to display a picture of an identification code on a display screen of network-enabled display device 300. The identification code can be any suitable sequence of numbers, characters, . . . , of any suitable alphabet (e.g., Greek alphabet, Roman alphabet, Cyrillic alphabet, . . . ) or numbering system (e.g., base-10 numbering system, base-16 numbering system, binary numbering system, . . . ). In at least one aspect, account management apparatus 302 can be pre-configured to generate an identification code utilizing characters from a selected alphabet or selected numbering system. Once generated, graphic login component 306 can be configured to store the identification code in a data store 308, and create the identification code as a picture, and convert the picture to a set of video frames. The set of video frames can then be displayed on a display screen of network-enabled display device 300 to facilitate displaying the identification code for viewing by the user/viewer of network-enabled display device 300. In various aspects of the subject disclosure, graphic login component 306 can initiate the video verification log in, in response to a login request by the user/viewer, in response to network-enabled display device 300 being powered on, in response to a network request to log into network-enabled display device 300 (e.g., through a network interface 316), or other suitable circumstance.

In response to displaying the identification code on the display screen of network-enabled display device 300, graphic login component 306 can await a data input to network-enabled display device 300. Generally, the data input will comprise an input to HMI input interface 304, from a remote control configured to communicate with network-enabled display device 300, or control buttons on a housing or panel of network-enabled display device 300, or the like. However, in some aspects the data input can instead be submitted over network interface 316 (over a data network connected to network-enabled display device 300 via network interface 316). Graphic login component 306 receives the data input from network-enabled display device 300 and can store the data input into a data store 308 of account management apparatus 302, or provide the data input directly to a verification component 310. Verification component 310 can be configured to compare the data input to stored user/viewer login credentials saved at data store 308. Based on the comparison, verification component can be configured to determine whether the input data comprises an input code that matches the identification code stored at data store 308. If no match occurs, verification component 310 can output a code error at a display screen of network-enabled display device 300. In one embodiment, graphic login component 306 can re-display the picture of the identification code and request the user/viewer re-enter the identification code in response to the code error. In an alternative embodiment, failure to match the stored identification code can re-initiate the video verification process, in which graphic login component 306 generates, saves and plays a new video identification code and prompts the user/viewer to input the new video identification code.

If verification component 310 determines a match has occurred, the user/viewer can be verified. In response to user/viewer verification, a SSO component 314 can retrieve login credentials for a set of online content/service accounts stored in an account data file 312, as well as network addresses for login servers 318-322. SSO component 314 can be configured to employ network interface 316 to initiate login procedures for at least a subset of the online content/service accounts.

Login servers 318-322 can compare respective login credentials to respective stored online account credentials and, if the login credentials match the stored credentials, log the user/viewer into an account(s). Results of the login procedures can be transmitted to network-enabled display device 300 in response thereto. A login management component 324 can be configured to receive the login results from the respective login servers 318-322. Further, login management component 324 can be configured to differentiate successful login results from unsuccessful login results, and output the differentiated results for display at network-enabled display device 300.

In the event of an unsuccessful login, SSO component 314 can be configured to display a prompt on the display screen of network-enabled display device 300 for user input of individual login credentials for an online content/service account associated with the unsuccessful login. SSO component 314 can receive user input of individual login credentials entered at network-enabled display device 300 and initiate a subsequent (e.g., a second) or additional login procedure to the login server associated with the unsuccessful login result. Login management component 324 can receive a re-login result in response to the second login procedure, and display the re-login result at the display screen of network-enabled display device 300. This can be repeated until all online content/service accounts are successfully logged in, until the user/viewer cancels SSO automated login for these accounts, until a predetermined maximum number of unsuccessful login results has been received, or the like, or a suitable combination thereof. As mentioned above, content or services associated with successfully logged in online accounts can be requested at network-enabled display device 300, and content/services received in response to those requests can be played, displayed, saved, etc., at network-enabled display device 300 or associated devices (e.g., a data store, an mp3 player, an mp4 player, a media player, and so on).

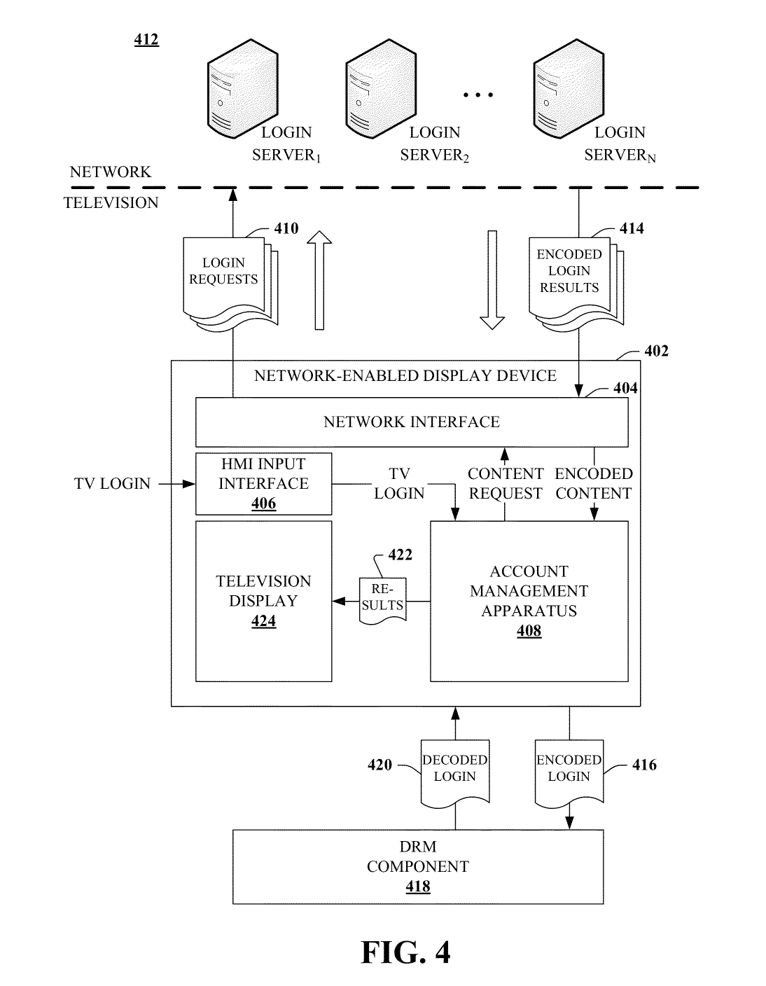

FIG. 4 illustrates a block diagram of an example system 400 configured to provide digital rights media protection in conjunction with SSO functionality for a network-enabled display device 402, according to still other aspects of the subject disclosure. Network-enabled display device 402 can comprise a network interface 404 configured to establish a connection with a data network, enabling network-enabled display device 402 to communicate electronically with other devices on the data network, and with other inter-connected networks and devices (e.g., the Internet). Network-enabled display device 402 can comprise an HMI input interface 406 to receive login credentials for a user account maintained by network-enabled display device 402, or a related account pertaining to television content or services. Received login credentials are verified by an account management apparatus 408, as described herein. If login is successful, account management apparatus 408 can initiate a set of SSO login requests 410 to a set of login servers 412 that perform login functionality for one or more online content/service accounts. The login servers can comprise login server₁, login server₂, . . . login server_{N}, where N is a suitable positive integer (collectively referred to as login servers 412). In response to successful login procedures, login servers 412 can transmit login results to network-enabled display device 402 in response to login requests 410. In at least one aspect of the subject disclosure, login results can be encoded according to a digital rights management (DRM) encoding protocol and transmitted in an encoded login results file 414. DRM encoding protocols are generally configured to limit decoding and playback of encoded content to playback devices that are DRM compliant. When connected to a DRM compliant display device, a DRM decoder can permit playback of encoded content, and restrict playback of encoded content when not connected to a DRM compliant display device. Accordingly, DRM encoding of login results can limit access to the online content/service accounts to DRM compliant playback devices.

As depicted, encoded login results 414 are received at network interface 404 and provided to account management apparatus 408. In turn, account management apparatus 408 can provide encoded login results 416 to a DRM component 418. DRM component can be configured to determine DRM compliance of network-enabled display device 402. If network-enabled display device 402 is not DRM compliant, a DRM error can be provided to account management apparatus 408 and a television display 424 of network-enabled display device 402. If network-enabled display device 402 is DRM compliant, DRM component 418 can decode the encoded login results 416 and output a decoded login 420 to account management apparatus 408, and such results 422 can be played on television display 424.

Network-enabled display device 402 can access content/services from a content server(s) associated with logged in online accounts. The content/services can also be DRM encoded to restrict playback of the content/services to DRM compliant devices. Content requests received by network-enabled display device 402 are submitted to content servers, and DRM encoded content received in response to those requests are provided to DRM component 418. Successfully decoded content can then be provided to television display 424 for playback.

System 400 provides for DRM decoding in conjunction with SSO functionality. DRM decoding can be employed for login results in response to SSO login procedures, in one aspect, and can also be employed for decoding content that is accessed in response to successful login to an online content/service account. As described in more detail below, SSO functionality and DRM decoding can also be implemented in conjunction with video user verification as described herein.

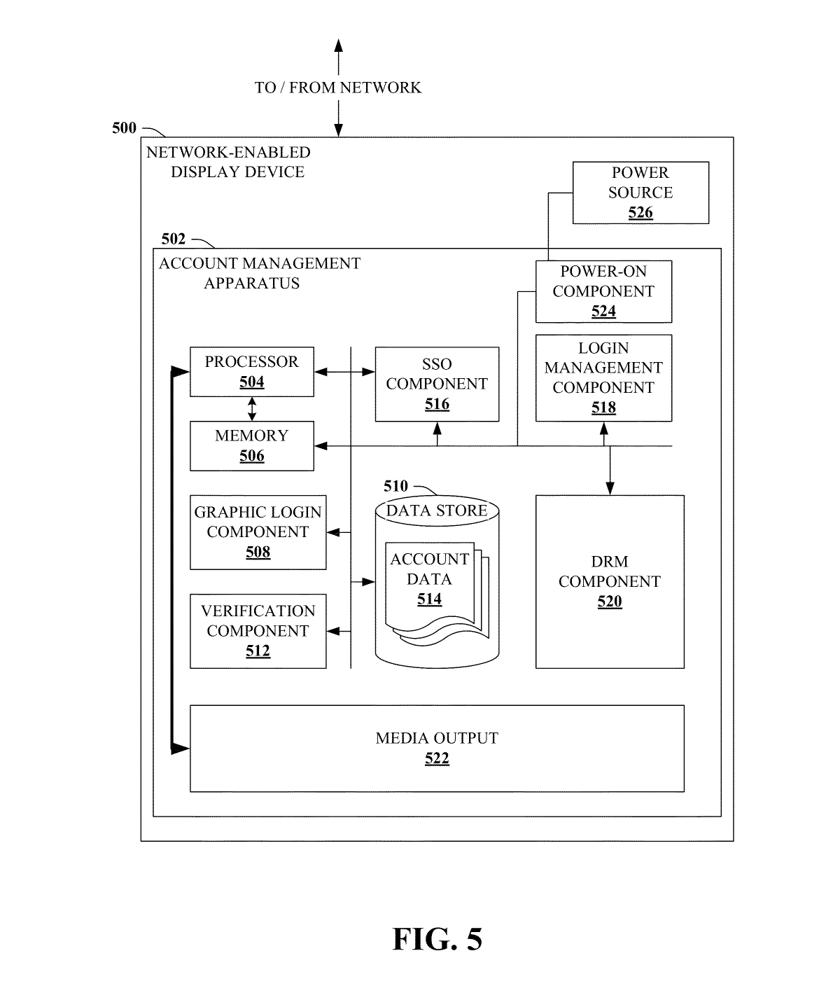

FIG. 5 depicts a block diagram of an example network-enabled display device 500 according to particular aspects of the subject disclosure. Network-enabled display device 500 can be configured for providing user verification for one or more television user accounts maintained by an account management apparatus 502 (e.g., see FIG. 2, infra). Additionally, network-enabled display device 500 can be configured to provide access to an aggregate of online content/service accounts in addition to online multimedia television content. For instance, a user can access e-mail, web traffic, and social networking applications over network-enabled display device 500 (as well as other online content or services), in addition to online television content. SSO functionality is provided for accessing an aggregate of account content and services, and DRM protection can be implemented in addition, to enable playback of DRM-protected content. Thus, network-enabled display device 500 can provide significant utility for online content consumption for a user/viewer of network-enabled display device 500.

Network-enabled display device 500 is configured to transmit and receive data over a data network (not depicted). Particularly, an account management apparatus 502 can employ the data network to facilitate user verification, online account login, content acquisition, or playback, or the like. Account management apparatus 502 can comprise a memory 506 configured for storing computer-executable components (or subsets thereof) of account management apparatus 502, and a processor 504 communicatively connected to memory 506 and configured to facilitate execution of at least one of the computer-executable components. In a particular aspect of the subject disclosure, account management apparatus 502 and one or more components and functions thereof can be triggered in response to a power-on event at network-enabled television. To this end, account management apparatus 502 can comprise a power-on component 524 connected to a power source 526 of network-enabled display device 500, and configured to detect a power-on event thereof. Processor 504 and memory 506 can proceed to execute one or more components of account management apparatus 502 in response to the power-on event. In other aspects, however, account management apparatus 502 need not be responsive to the power-on event of network-enabled display device 500, and responsive to commands or controls received by network-enabled display device 500 instead. I still other aspects, a combination of the foregoing functionality can be integrated into account management apparatus 502 and network-enabled display device 500.

Account management apparatus 502 can further comprise a graphic login component 508 configured to display a picture of an identification code on a display screen (media output 522) of network-enabled display device 500, and request entry of the identification code therein (e.g., via an HMI interface). A data input received in response to the request can be stored in a data store 510. A verification component 512 can be configured to determine whether the data input matches the identification code. If a match is not identified, a code error can be displayed at media output 522, and re-entry of data input requested. If a match is identified, verification component 512 can provide access to a user account maintained by account management apparatus 502, or request login credentials for such a user account to match with stored login credentials saved at an account data file 514.

Upon identifying the matching identification code or activation of the user account, a SSO component 516 can be configured to reference stored user login credentials for a plurality of online content accounts saved at account data file 514, and configured to initiate login procedures for at least a subset of the plurality of online content accounts. Results of the login procedures can be received at a login management component 518 configured to differentiate between successful and unsuccessful login attempts, and display the differentiated results. Successful login attempts can result in activation of an online account and access to content/services of such account at network-enabled display device 500. Login management component 518 can request re-entry of login credentials for unsuccessful login attempts, to facilitate a further login procedure by SSO component 516 utilizing re-entered login credentials.

In at least one aspect of the subject disclosure, login results can be DRM encoded, and provided to a DRM component 520 for decoding. Decoded login results can be treated as described above by login management component 518. Improper decoding (or improper DRM credentials of network-enabled display device 500) can result in a DRM error displayed at media output 522 of network-enabled display device 500. Additionally, DRM component 520 can receive DRM encoded network content or services and decode the content according to DRM protocols employed by DRM component 520. Decoded content can be played at media output 522, for instance, played at a display screen, audio output, or the like.

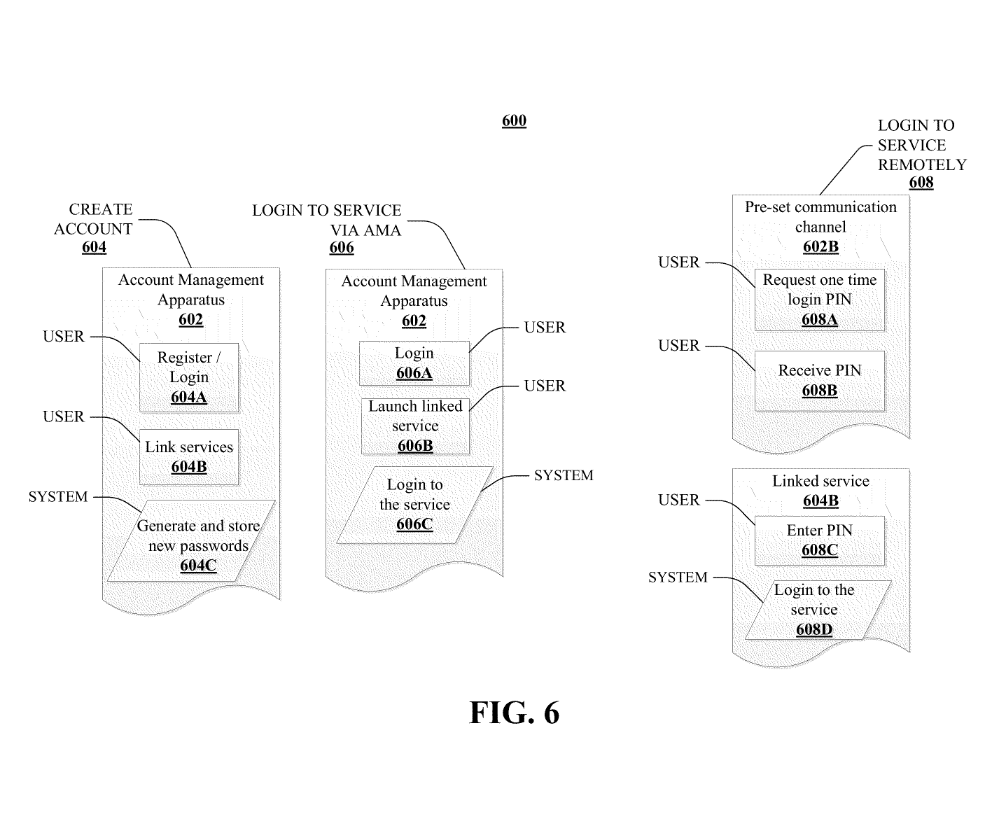

FIG. 6 illustrates a block diagram of an example system 600 that facilitates remote access to online content or to (SSO) functionality according to further aspects of the subject disclosure. System 600 can comprise an account management apparatus 602 configured to generate and maintain a set of user accounts for users of a network-enabled display device (e.g., network-enabled television, set-top box, television control box, digital video recorder, tablet PC, computer, . . . ). These user accounts can act as an access portal to user content and services on the network-enabled display device in response to successful user login. The user accounts can provide access to one or more other online content/service accounts linked to respective user accounts. In at least one aspect, a user account(s) can also provide access to a particular type of online content/service from a service provider linked with the network-enabled display device (e.g., multimedia television content, . . . ). Respective users can establish content/service accounts to be linked to their user account, login credentials for their user account, as well as remote login or content/service access parameters over remote login, as described below.

To interact with system 600, a user can perform a create account action 604. Creating an account can comprise a registration or login action 604A in which the user registers for or logs into a user account. The user account can be set to one of a series of security levels selected by the user, in a particular aspect of the subject disclosure. Further, the user can choose to activate remote login, and specify an approved communication channel or series of communication channels (e.g., with preference rankings) over which remote login is to be allowed. Additionally, the user can provide some identification information for a device, which account management apparatus 602 can utilized to validate an authorized remote login by matching the identification information with information pertaining to a device attempting to log in remotely to account management apparatus 602. Suitable identifying information can include, for instance, a serial number, part number, IP address, mobile phone number, international mobile equipment identifier, or the like, or a suitable combination thereto.

Upon establishing a user account, the user can perform a link services action 604B, and select a set of online content or service applications that the user is registered for, and link the content/service applications to the user account created above. Account management apparatus 602 can be configured to perform a generate login credentials and store login credentials action 604C for one or more of the linked services. In one aspect, respective login credentials can be generated via a suitable hard-to-guess code generation algorithm for each of the linked services, whereas in other cases one or more generated login credentials can be re-used for a subset of the linked services. The login credentials can be encrypted, and stored local to account management apparatus 602, or remotely (e.g., cloud storage, . . . ).

At 606 a user can perform a login to service action, utilizing account management apparatus 602. In effect, logging directly into account management apparatus 602 facilitates access to content or services associated with the user's user account and associated linked services, on a display device connected to account management apparatus 602. Thus, the user can perform a login action 606A utilizing login credentials for the user account, and can perform a launch linked service action 606B, in which the user activates an application associated with a service that is linked to the user's user account. In response to activation of the application, account management apparatus 602 can perform a login action 606C, and retrieve stored login credentials for the activated application, and use the stored login credentials to access a login service for the activated service. Upon successful login, the user can access content associated with the activated service.

When not located near the display device or account management apparatus 602, the user can perform a login to service remotely action 608. Utilizing a pre-determined communication channel (e.g., e-mail channel, local area network data communication, wide area network data communication, text message, short message, multimedia message, phone call, mobile phone call, . . . ), account management apparatus 602 can facilitate a user requesting a one-time login PIN for a particular service 608A. In response, the pre-determined communication channel 602B can be utilized to transmit a one-time PIN for remote login to the particular service. In some aspects, account management apparatus 602 can reset user login credentials—generating and storing a new set of such credentials—for the particular service in response to receiving the one-time login PIN request. In further aspects, the one-time PIN can be given a limited life for remote login, beyond which time a time-out error is transmitted in response to the remote login communication other than re-requesting the one-time PIN. A linked service 604B for which the user requested the one-time PIN can be accessed upon entry of the PIN 608C by the user, optionally within the limited life established by account management apparatus 602. Account management apparatus 602 can then use login credentials to log the user in 608D to the requested service, and provide access to content or services associated there with over the pre-determined communication channel.

The aforementioned diagrams have been described with respect to interaction between several systems, apparatuses, components, user interfaces, and display indicators. It should be appreciated that such diagrams can include those components or systems specified therein, some of the specified components, or additional components. For example, a system could include network-enabled display device 500 communicatively connected to login servers 412. Sub-components could also be implemented as components electrically connected to other sub-components rather than included within a parent component. Additionally, it should be noted that two or more components could be combined into a single component providing aggregate functionality. For instance, verification component 110 can include SSO component 116 to facilitate authorizing a user of a network-enabled television and initiating multiple login procedures for stored online accounts in response to authorizing the user, by way of a single component. Components of the disclosed systems and apparatuses can also interact with one or more other components not specifically described herein but known by those of skill in the art, or made known to one of skill in the art by way of the context provided herein.

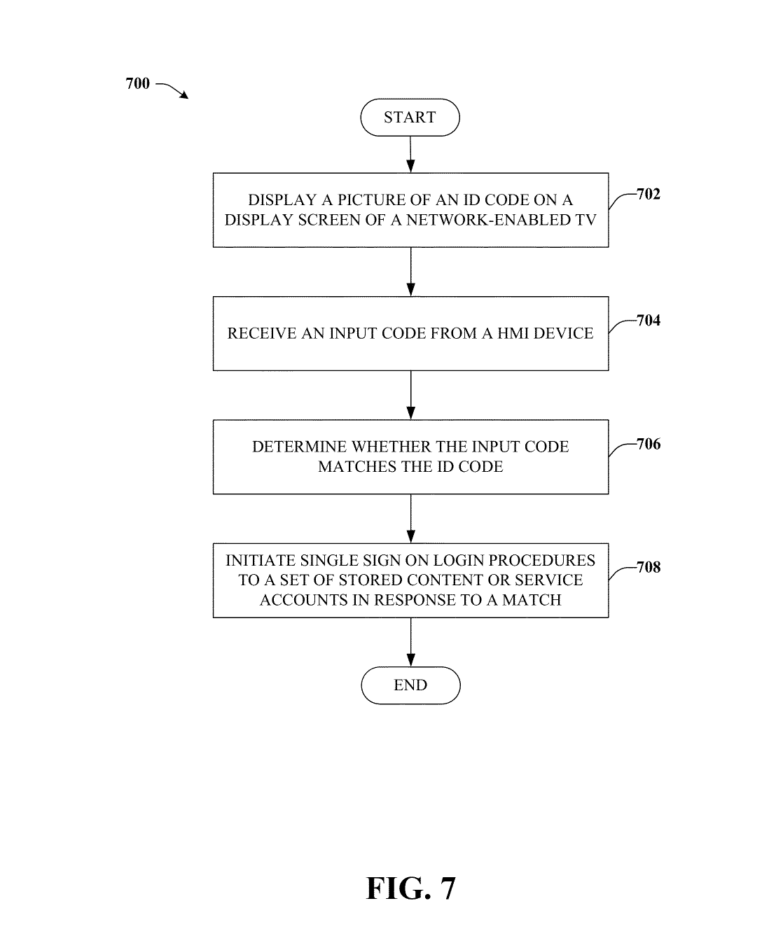

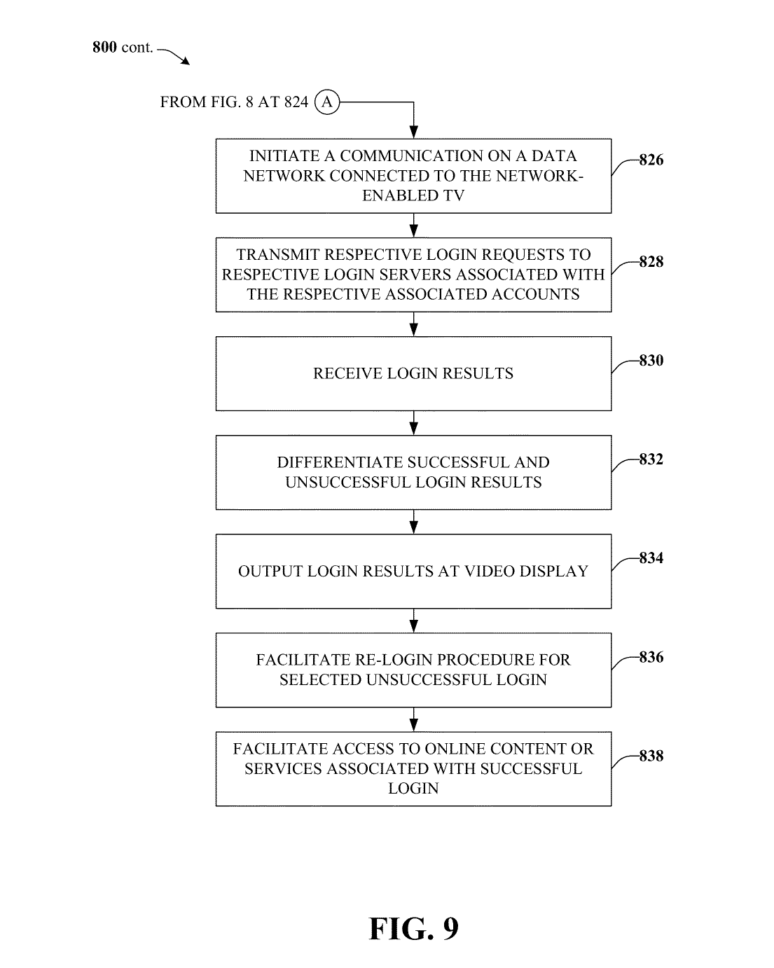

In view of the exemplary diagrams described supra, process methods that may be implemented in accordance with the disclosed subject matter will be better appreciated with reference to the flow chart of FIGS. 7-11. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Additionally, it should be further appreciated that the methods disclosed hereinafter and throughout this specification are capable of being stored on an article of manufacture to facilitate transporting and transferring such methods to an electronic device. The term article of manufacture, as used, is intended to encompass a computer program accessible from any computer-readable device, device in conjunction with a carrier, or storage medium.

FIG. 7 illustrates a block diagram of an example method 700 for providing user account services for a network-enabled television, according to one or more aspects of the subject disclosure. At 702, method 700 can comprise displaying a picture of an identification code on a display screen of a network-enabled television. The identification code can comprise any suitable sequence of characters, having one or more fonts, font sizes, font effects (e.g., bold, italic, strikethrough, . . . ), text colors, and so on. The sequence of characters can comprise characters from any suitable alphabet, or any suitable numbering system. In at least one aspect, method 700 can comprise facilitating user entry of a default alphabet(s) or numbering system(s) for generating the sequence of characters. Once generated, the sequence of characters can be saved for reference and created as a picture according to a suitable graphic data format, or graphic protocol. The picture can then be converted to a set of video frames, for playback and display of the identification code at the network-enabled television.

At 704, method 700 can comprise receiving an input code from a HMI device associated with the network-enabled television. The HMI device can comprise a remote control input device, or buttons, switches, dials, levers, etc., on a housing panel (e.g., front panel, side panel, rear panel, . . . ) of the network-enabled television, or the like. At 706, method 700 can comprise determining whether the input code matches the identification code, and at 708, method 700 can comprise referencing stored user login credentials for a plurality of online content accounts and initiating login procedures for the plurality of online content accounts utilizing the stored user login credentials, in response to the input code matching the identification code.

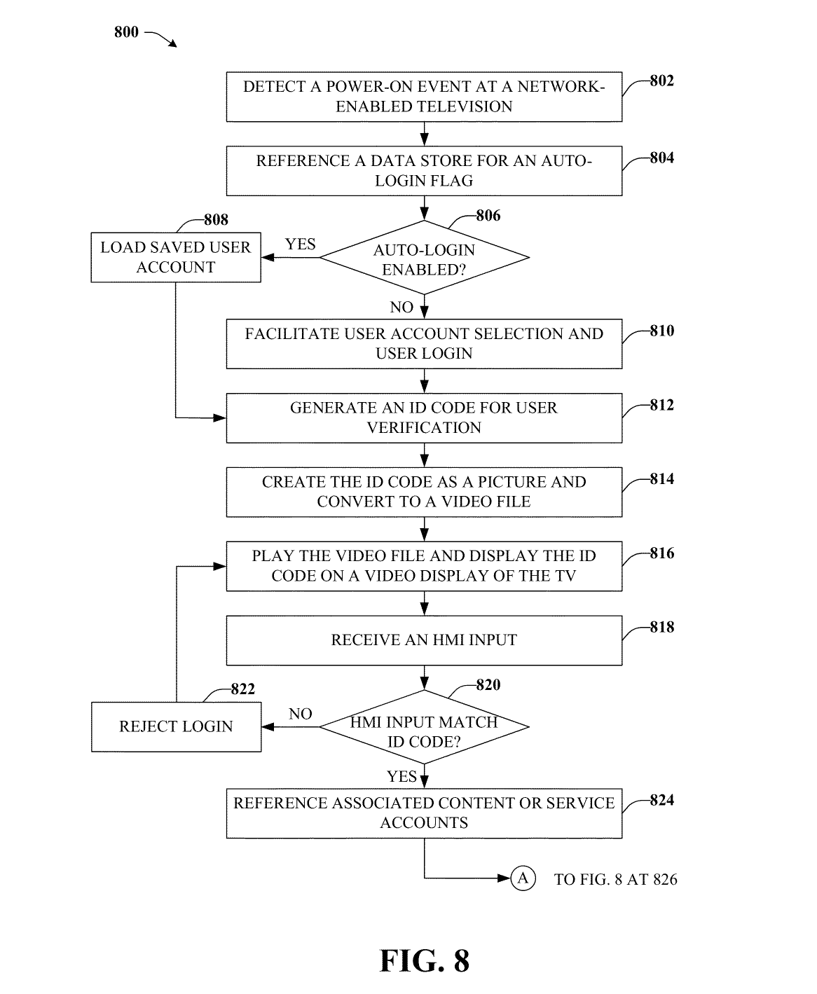

FIG. 8 illustrates a flowchart of an example method 800 for providing single sign on account functionality for a network-enabled television, according to particular aspects of the subject disclosure. At 802, method 800 can comprise detecting a power-on event at a network-enabled television. At 804, method 800 can comprise referencing a data store maintaining an auto-login flag for the network-enabled television. At 806, method 800 can comprise determining whether automated account login is activated for the network-enabled television (e.g., within a control setting or operation setting of the network-enabled television). If automated account login is activated, method 800 can proceed to 808 and load a default user account associated with the automated account login in response to determining the automated login is activated; otherwise, method 800 proceeds to 810.

At 810, method 800 can comprise facilitating user account selection of stored user accounts associated with the network-enabled television, and facilitating user login to a selected user account. At 812, method 800 can comprise generating and storing an identification code for user verification. At 814, method 800 can comprise creating the identification code as a picture and converting the picture to a video file. At 816, method 800 can comprise playing the video file and displaying the identification code on a video display of the network-enabled television. At 818, method can receive an HMI input at the network-enabled television. At 820, a determination can be made as to whether the HMI input matched the stored identification code. If the HMI input does not match the stored identification code, method 800 proceeds to 822 and rejects the code and outputs a code error at a display screen of the network-enabled television. Method 800 then returns to reference number 816. If the HMI input does match the identification code, method 800 can proceed to 824 and authorize user access to the network-enabled television and reference associated online content or service accounts related thereto. Method 800 continues at FIG. 8, below.

Referring now to FIG. 8, at 826, method 800 can comprise initiating a communication on a data network connected to the network-enabled television. At 828, method 800 can comprise transmitting respective login requests to respective login servers associated with the respective online content or service accounts. At 830, method 800 can comprise receiving results of the login requests. At 832, method 800 can comprise differentiating successful login results and unsuccessful login results. At 834, method 800 can comprise outputting login results at a display screen of the network-enabled television. At 836, method 800 can comprise facilitating re-login for selected unsuccessful login attempts. At 838, method 800 can comprise facilitating access to content or services available to successfully logged in online service or content accounts. The content or services can include, for example, e-mail, social networking, blog or forum access, or the like, or suitable combinations thereof.

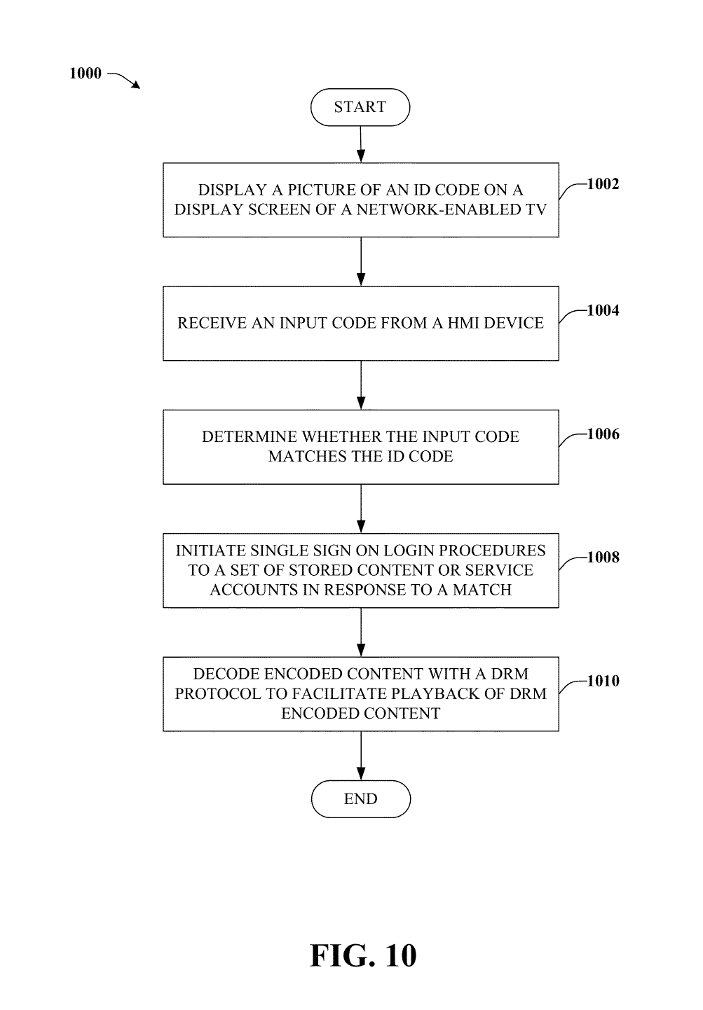

FIG. 10 illustrates a flowchart of a sample method 1000 for providing SSO functionality for a network-enabled television according to one or more aspects. At 1002, method 1000 can comprise displaying a picture of an identification code on a display screen of the network-enabled television. At 1004, method 1000 can comprise receiving an input code from an HMI input device. At 1006, method 1000 can comprise determining whether the input code matches the identification code. At 1008, method 1000 can comprise initiating SSO login procedures for a set of stored online content or service accounts in response to the input code matching the identification code. At 1010, method 1000 can comprise decoding encoded login results with a DRM protocol to facilitate completing login procedures to the online content or service accounts, and if successful, decoding encoded content or services associated with successfully logged in accounts.

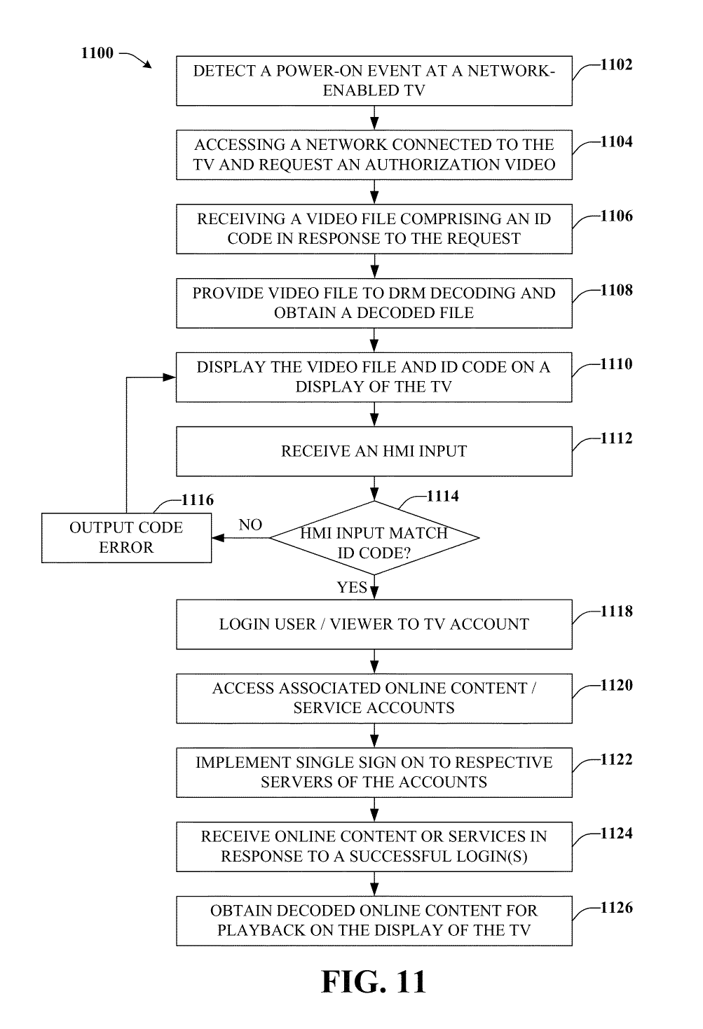

FIG. 11 illustrates a flowchart of a sample method 1100 for providing video identification code matching for user authorization and DRM decoding for a network-enabled television, according to still other aspects of the subject disclosure. At 1102, method 1100 can comprise detecting a power-on event at the network-enabled television. At 1104, method 1100 can comprise accessing a network connected to the network-enabled television and request an authorization video from an authorization server. At 1106, method 1100 can comprise receiving a video file comprising an identification code in response to the request. At 1108, method 1100 can comprise providing the video file to a DRM decoding entity and obtaining a decoded video file. At 1111, method 1100 can comprise displaying the decoded video file and identification code on a display of the network-enabled television. At 1112, method 1100 can comprise receiving an HMI input at the network-enabled television. At 1114, method 1100 can comprise determining whether the HMI input matches the identification code. If not, method 1100 proceeds to 1116 and outputs a code error at the network-enabled television. Otherwise, method 1100 can proceed to 1118.

At 1118, method 1100 can comprise logging a user/viewer of the network-enabled television into a television account associated with the network-enabled television. At 1120, method 1100 can comprise accessing associated online content/service accounts associated with the television account. At 1122, method 1100 can comprise implementing SSO login procedures to respective login servers for the associated online content/service accounts. At 1124, method 1100 can comprise receiving online content or services in response to a successful login. At 1126, method 1100 can comprise providing the content or services to the DRM decoding entity and obtaining decoded online content or services for playback a the display screen of the network-enabled television.

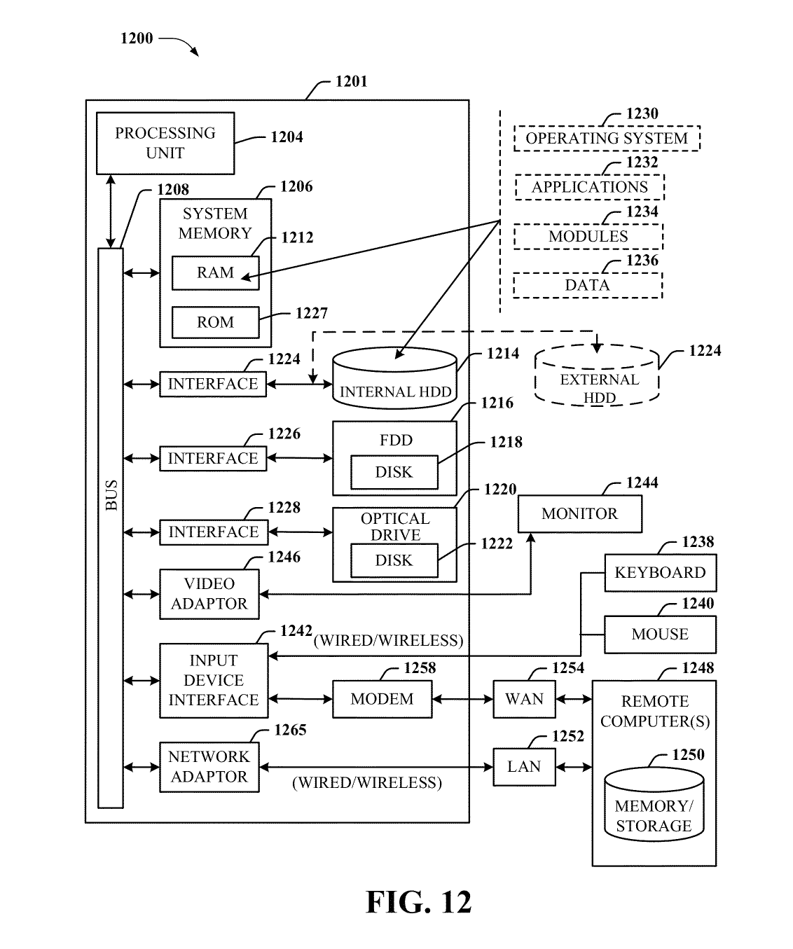

With reference to FIG. 12, an exemplary environment 1200 for implementing various aspects described herein includes a computer 1202, the computer 1202 including a processing unit 1204, a system memory 1206 and a system bus 1208. The system bus 1208 connects system components including, but not limited to, the system memory 1206 to the processing unit 1204. The processing unit 1204 can be any of various commercially available processors. Dual microprocessors and other multi processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 can also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1212 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is to be appreciated that aspects of the subject disclosure can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 through an interface, such as a video adapter 1246. In addition to the monitor 1244, a computer typically includes other peripheral output devices (not shown), such as speakers, printers, etc.

The computer 1202 can operate in a networked environment using logical connections by wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or can be connected to a communications server on the WAN 1254, or has other means for establishing communications over the WAN 1254, such as by way of the Internet. The modem 1258, which can be internal or external and a wired or wireless device, is connected to the system bus 1208 through the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi® and Bluetooth™ wireless technologies. Thus, the communication can be a predefined structure as with a conventional network or simply an ad hoc communication between at least two devices.

Wi-Fi, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), or other bands (e.g., 802.11g, 802.11n, . . . ) so the networks can provide real-world performance similar to the basic 10BaseT wired Ethernet networks used in many offices.

FIG. 12 provides a schematic diagram of an exemplary networked or distributed computing environment. The distributed computing environment comprises computing objects 1310, 1312, etc. and computing objects or devices 1320, 1322, 1324, 1326, 1328, etc., which may include programs, methods, data stores, programmable logic, etc., as represented by applications 1330, 1332, 1334, 1336, 1338 and data store(s) 1340. It can be appreciated that computing objects 1310, 1312, etc. and computing objects or devices 1320, 1322, 1324, 1326, 1328, etc. may comprise different devices, including network-enabled display device 104 (FIG. 1), network-enabled television 200 (FIG. 2), and network-enabled display devices 300 (FIG. 3), 402 (FIG. 4), 500 (FIG. 5), or other devices such as a mobile phone, personal digital assistant (PDA), audio/video device, MP3 players, personal computer, laptop, etc. It should be further appreciated that data store(s) 1340 can include data store 112 (FIG. 1), data store 208 (FIG. 2), data store 308 (FIG. 3), or data store 510 (FIG. 5).

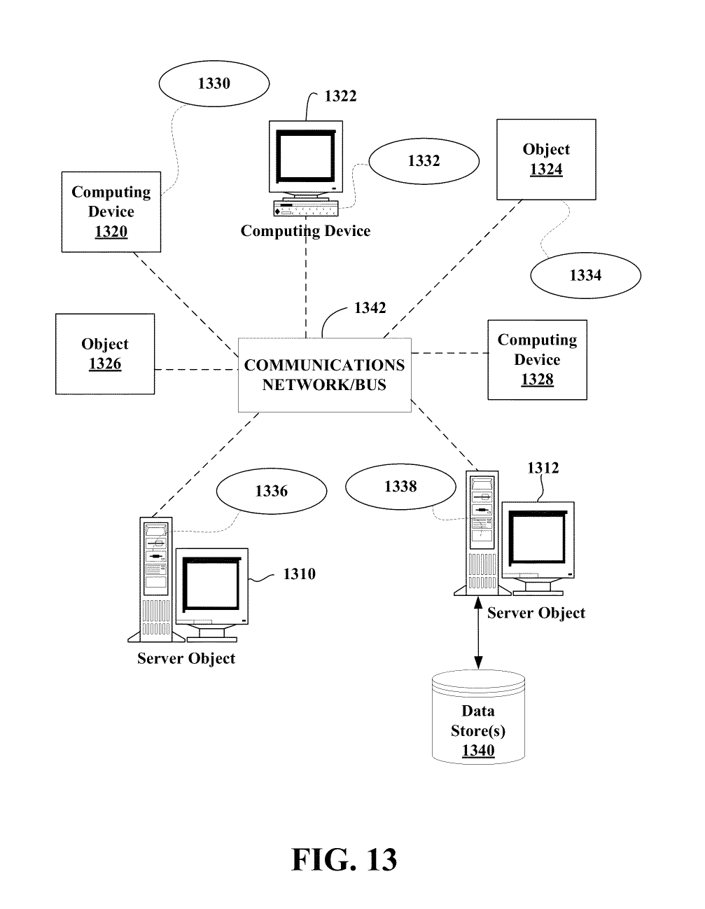

Each computing object 1310, 1312, etc. and computing objects or devices 1320, 1322, 1324, 1326, 1328, etc. can communicate with one or more other computing objects 1310, 1312, etc. and computing objects or devices 1320, 1322, 1324, 1326, 1328, etc. by way of the communications network 1342, either directly or indirectly. Even though illustrated as a single element in FIG. 13, communications network 1342 may comprise other computing objects and computing devices that provide services to the system of FIG. 13, and/or may represent multiple interconnected networks, which are not shown. Each computing object 1310, 1312, etc. or computing object or devices 1320, 1322, 1324, 1326, 1328, etc. can also contain an application, such as applications 1330, 1332, 1334, 1336, 1338, that might make use of an API, or other object, software, firmware and/or hardware, suitable for communication with or implementation of the techniques for search augmented menu and configuration functions provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems for search augmented menu and configuration functions as described in various embodiments.

Thus, a host of network topologies and network infrastructures, such as client/server, peer-to-peer, or hybrid architectures, can be utilized. One or more of these network topologies can be employed by network-enabled television 104, 200, 302, 600 for communicating with a network. The “client” is a member of a class or group that uses the services of another class or group to which it is not related. A client can be a process, i.e., roughly a set of instructions or tasks, that requests a service provided by another program or process. The client process utilizes the requested service, in some cases without having to “know” any working details about the other program or the service itself.

In a client/server architecture, particularly a networked system, a client is usually a computer that accesses shared network resources provided by another computer, e.g., a server. In the illustration of FIG. 13, as a non-limiting example, computing objects or devices 1320, 1322, 1324, 1326, 1328, etc. can be thought of as clients and computing objects 1310, 1312, etc. can be thought of as servers where computing objects 1310, 1312, etc., acting as servers provide data services, such as receiving data from client computing objects or devices 1320, 1322, 1324, 1326, 1328, etc., storing of data, processing of data, transmitting data to client computing objects or devices 1320, 1322, 1324, 1326, 1328, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1342 or bus is the Internet, for example, the computing objects 1310, 1312, etc. can be Web servers with which other computing objects or devices 1320, 1322, 1324, 1326, 1328, etc. communicate via any of a number of known protocols, such as the hypertext transfer protocol (HTTP). Computing objects 1310, 1312, etc. acting as servers may also serve as clients, e.g., computing objects or devices 1320, 1322, 1324, 1326, 1328, etc., as may be characteristic of a distributed computing environment.

The subject matter described herein can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect or design described herein as “exemplary,” “demonstrative,” or the like, is not necessarily to be construed as preferred or advantageous over other aspects or designs, nor is it meant to preclude equivalent exemplary structures and techniques known to those of ordinary skill in the art.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A method for managing online content services, comprising:
displaying a picture of an identification code on a display screen of a network-enabled display device;
receiving an input code from a human interface device associated with the network-enabled display device;
determining whether the input code matches the identification code; and
referencing stored user login credentials for a plurality of online content accounts, and initiating login procedures for the plurality of online content accounts utilizing the stored user login credentials, in response to the input code matching the identification code.

2. The method of claim 1, further comprising displaying on the display screen a set of user accounts maintained by the network-enabled display device and receiving a selection of one of the set of user accounts from the human interface device.

3. The method of claim 2, wherein the displaying the picture of the identification code is in response to receiving the selection of the one of the set of user accounts.

4. The method of claim 2, wherein the referencing the stored user login credentials further comprises accessing a data store associated with the network-enabled display device and retrieving respective sets of stored login credentials for at least a subset of the plurality of online content accounts, wherein the plurality of online content accounts are linked with the one of the set of user accounts.

5. The method of claim 1, further comprising initiating a network communication over a data network communicatively connected to the network-enabled display device, and employing the network communication to initiate the login procedures for the plurality of online content accounts.

6. The method of claim 1, further comprising referencing a data store and accessing respective network addresses for respective login servers that manage account login functionality for respective subsets of the plurality of online content accounts.

7. The method of claim 6, further comprising employing the respective network addresses to transmit respective login requests to respective ones of the login servers, the respective login requests comprise respective subsets of the stored user login credentials.

8. The method of claim 1, further comprising:
receiving respective login results for respective ones of the plurality of online content accounts;
differentiating failed login results and successful login results for respective ones of the plurality of content accounts; and
displaying failed or successful login results for associated ones of the plurality of content accounts.

9. The method of claim 1, wherein the plurality of online content accounts comprise at least one of an e-mail account, a social network account, an online multimedia television content account, a web page account, a message board account, or a network messaging account.

10. A system for secure single sign on access to a set of network communication or content services, comprising:
a memory storing computer-executable components;
a processor communicatively connected to the memory and configured to facilitate execution of at least one of the computer-executable components, the computer-executable components comprising:
a data input component configured to receive a data input at a network-enabled display device from a human interface device configured for input of data to the network-enabled display device;
a login component configured to compare the data input to stored television login credentials associated with television content services and determine whether the data input matches the stored television login credentials;
an account management component configured to access respective sets of stored services login credentials for a plurality of online services accounts and, in response to the data input matching the stored television login credentials, initiate respective login procedures for the plurality of online services accounts; and
a digital rights management (DRM) component configured to extract content from a DRM encoded signal according to a DRM decoding protocol, in response to a successful login procedure.

11. The system of claim 10, further comprising a data store communicatively connected to the network-enabled display device configured to save the stored television login credentials and the respective sets of stored services login credentials.

12. The system of claim 10, further comprising a set of applications providing user access to one or more of the plurality of online services accounts via the network-enabled display device.

13. The system of claim 12, wherein at least one of the set of applications is configured to provide encoded multimedia content received from a network server to the DRM component for DRM decoding.

14. The system of claim 13, further comprising a playback component configured to receive DRM decoded multimedia content from the at least one of the set of applications, and to render at least some of the DRM decoded multimedia content on a display device of the network-enabled display device.

15. The system of claim 13, wherein respective ones of the set of applications are configured to transmit content requests to respective content servers associated with respective ones of the plurality of online services accounts, and are further configured to provide encoded content received from the respective content servers to the DRM component to decode the encoded content.

16. A system for secure single sign on access to online content services, comprising:
a memory storing computer-executable components;
a processor communicatively connected to the memory and configured to facilitate execution of at least one of the computer-executable components, the computer-executable components comprising:
a graphic login component configured to display a picture of an identification code on a display screen of a network-enabled display device and receive an input code from a human interface device associated with the network-enabled display device;
a verification component configured to determine whether the input code matches the identification code;
a single sign on component configured to reference stored user login credentials for a plurality of online content accounts, and initiate login procedures for at least a subset of the plurality of online content accounts, in response to the input code matching the identification code; and
a digital rights management (DRM) component configured to decode encoded content received in response to successful login to at least one of the plurality of online content accounts to facilitate playback of the encoded content at the network-enabled display device.

17. The system of claim 16, further comprising a data store configured to store the identification code and the stored user login credentials.

18. The system of claim 16, further comprising a network interface to a data network, wherein the single sign on component employs the network interface to communicate with respective online content servers to initiate the login procedures for at least the subset of the plurality of online content accounts.

19. The system of claim 16, wherein the single sign on component is configured to access stored network addresses of respective login servers associated with respective ones of the plurality of online content accounts.

20. The system of claim 16, further comprising a login management component configured to receive login results from respective login servers associated with respective ones of the at least the subset of the plurality of online content accounts, in response to the single sign on component initiating the login procedures.

21. The system of claim 20, wherein the login management component is further configured to differentiate successful login results from unsuccessful login results, and output the differentiated results for display at the network-enabled display device.

22. The system of claim 21, wherein the single sign on component is further configured to prompt for user input of individual login credentials at a display device of the network-enabled display device for one of the plurality of online content accounts associated with an unsuccessful login result.

23. The system of claim 22, wherein the single sign on component is further configured to receive user input of individual login credentials at the network-enabled display device and initiate a second login procedure to a login server associated with the unsuccessful login result.

24. The system of claim 23, wherein the login management component is further configured to receive a re-login result of the second login procedure from the login server associated with the unsuccessful login result and display the re-login result at the network-enabled display device.
